(19) United States
(12) Patent Application Publication
(10) Pub. No.: US 2013/0266350 A1
(43) Pub. Date: Oct. 10, 2013

(54) IMAGE FORMING APPARATUS AND FIXING DEVICE

(71) Applicant: FUJI XEROX CO., LTD., Tokyo (JP)

(72) Inventors: Masaki NAGATA, Kanagawa (JP); Seiji TAIRA, Kanagawa (JP); Tomofumi SUZUKI, Kanagawa (JP)

(73) Assignee: FUJI XEROX CO., LTD., Tokyo (JP)

(21) Appl. No.: 13/705,604

(22) Filed: Dec. 5, 2012

(30) Foreign Application Priority Data
Apr. 9, 2012 (JP) 2012-088582

(51) Int. Cl. G03G 15/20

(52) U.S. Cl. CPC G03G 15/2028
USPC 399/322

(57) ABSTRACT

An image forming apparatus includes a fixing unit having a fixing member fixing a toner image onto a recording medium and a fixation pressing member coming into pressure contact with the fixing member to form a fixation pressing area, through which the recording medium passes, between the two members; a transport unit transporting the recording medium output from the fixing unit; and a guide unit disposed between the fixing and transport units and having a substantially arc-shaped transport path along which the output recording medium is guided and transported toward the transport unit. The guide unit has a substantially rib-shaped guide extending along the transport path and coming into contact with the recording medium at a predetermined position of the guide to guide the recording medium, and a recess provided downstream, in a recording-medium transport direction, of the predetermined position and recessed inward from the substantially arc-shaped transport path.

### CROSS-REFERENCE TO RELATED APPLICATIONS

This application is based on and claims priority under 35 USC 119 from Japanese Patent Application No. 2012-088582 filed Apr. 9, 2012.

### BACKGROUND

### Technical Field

The present invention relates to image fixing apparatuses and fixing devices.

### SUMMARY

According to an aspect of the invention, there is provided an image forming apparatus including a fixing unit, a transport unit, and a guide unit. The fixing unit has a fixing member that fixes a toner image onto a recording medium and a fixation pressing member that comes into pressure contact with an outer peripheral surface of the fixing member so that a fixation pressing area through which the recording medium bearing an unfixed image passes is formed between the fixation pressing member and the fixing member. The transport unit transports the recording medium output from the fixing unit. The guide unit is disposed between the fixing unit and the transport unit and has a substantially arc-shaped transport path along which the recording medium output from the fixing unit is guided and transported toward the transport unit. The guide unit has a substantially rib-shaped guide that extends along the transport path for the recording medium and comes into contact with the recording medium at a predetermined position of the guide so as to guide the recording medium, and a recess that is provided downstream, in a transport direction of the recording medium, of the predetermined position of the guide and is recessed inward from the substantially arc-shaped transport path.

### BRIEF DESCRIPTION OF THE DRAWINGS

An exemplary embodiment of the present invention will be described in detail based on the following figures, wherein:

FIG. 1 schematically illustrates the configuration of an image forming apparatus according to an exemplary embodiment;

FIG. 2 is an enlarged view of one area in FIG. 1;

FIG. 3 is a perspective view of a guide member;

FIG. 4 illustrates the guide member, as viewed from a direction indicated by an arrow IV in FIG. 3;

FIG. 5 illustrates a cutout formed in each rib; and

FIGS. 6A and 6B illustrate a comparison of the accumulation state of a separated toner, between an example provided with the cutouts and an example not provided with the cutouts.

### DETAILED DESCRIPTION

### Image Forming Apparatus

An exemplary embodiment of the present invention will be described in detail below with reference to the appended drawings.

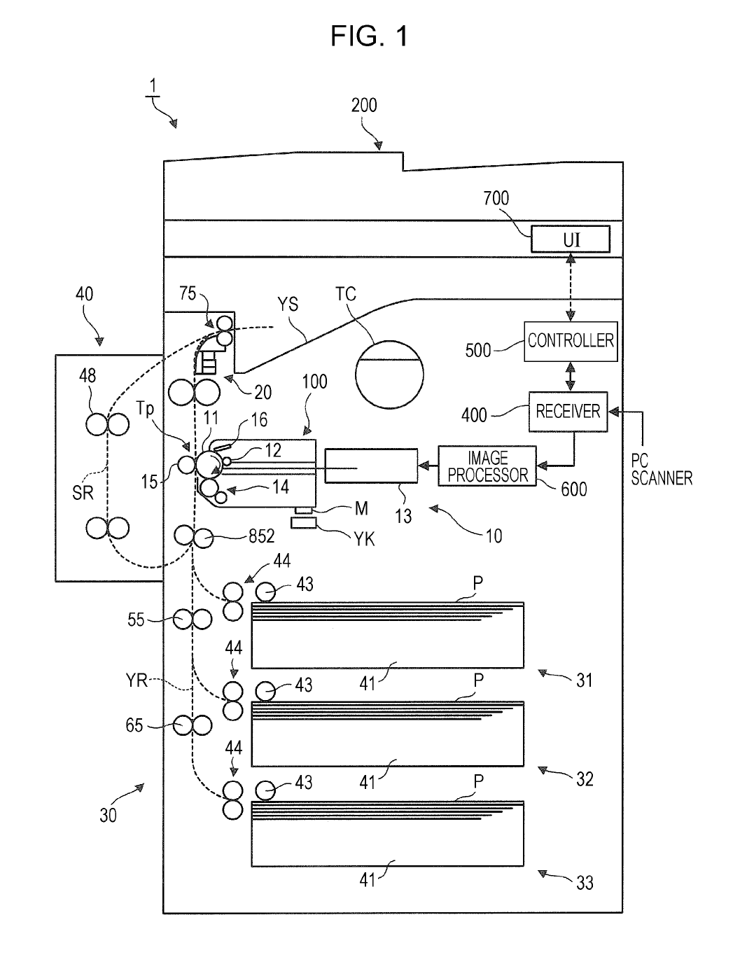

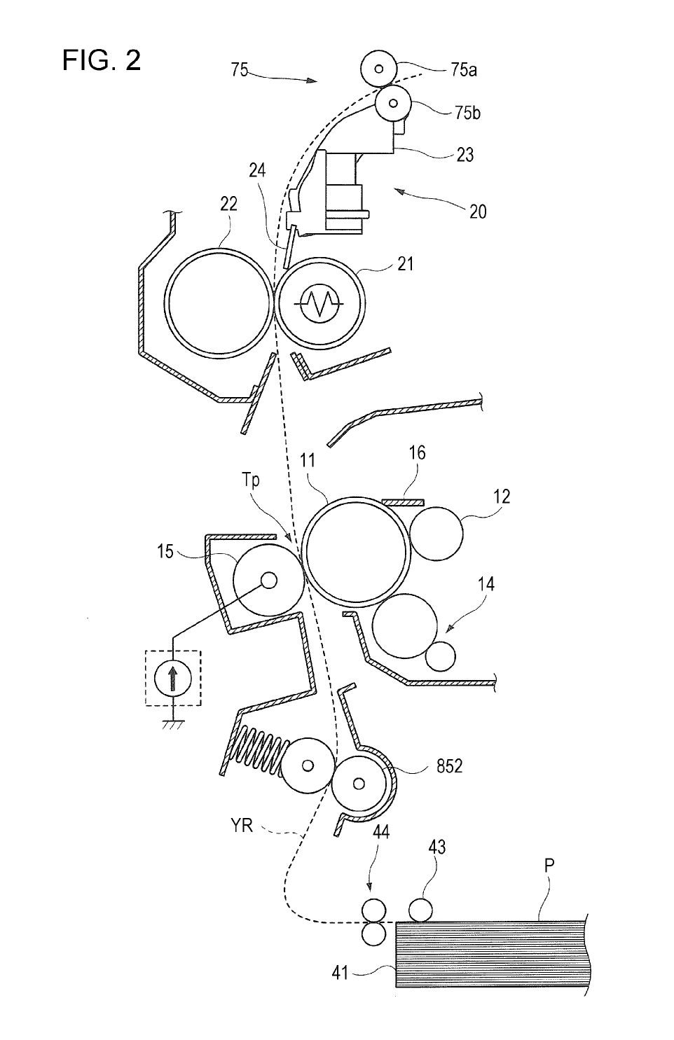

FIG. 1 schematically illustrates the configuration of an image forming apparatus 1 according to the exemplary embodiment. FIG. 2 is an enlarged view of one area in FIG. 1. The image forming apparatus 1 will be described below with reference to FIGS. 1 and 2.

The image forming apparatus 1 shown in FIGS. 1 and 2 includes an image forming section 10 that forms a toner image onto a sheet (i.e., recording medium) P, a fixing section 20 as an example of a fixing device that fixes the toner image formed on the sheet P by the image forming section 10 onto the sheet P, a sheet feeding section 30 that accommodates sheets P and feeds each sheet P to the image forming section 10 by separating the sheets P in a one-by-one fashion, a sheet inverting mechanism 40 that inverts a sheet P, and an output roller 75 as an example of a transport unit that transports each sheet P output from the fixing section 20.

The image forming apparatus 1 is provided with a toner cartridge TC that is attachable thereto and detachable therefrom and contains a toner to be supplied to the image forming section 10, and a sheet stack section YS on which each sheet P passing through the fixing section 20 is stacked.

Furthermore, the image forming apparatus 1 is provided with a receiver 400 that receives image data from a scanner (image reading device) 200 provided at the upper portion of the image forming apparatus 1, a personal computer (PC) (not shown), or the like. Moreover, the image forming apparatus 1 is provided with a controller 500 that controls the overall operation of the image forming section 10, the fixing section 20, the sheet feeding section 30, and the sheet inverting mechanism 40, and is also provided with an image processor 600 that performs image processing on the image data received by the receiver 400 and then outputs the image data to the image forming section 10.

Furthermore, the image forming apparatus 1 is provided with a user interface (UI) 700 formed of a display panel. The UI 700 receives a command from a user and displays a message to the user. The controller 500 includes a central processing unit (CPU), a read-only memory (ROM), a random access memory (RAM), and a hard disk drive (HDD) (all of which are not shown). The CPU executes a processing program. The ROM stores various kinds of programs, various kinds of tables, parameters, etc. The RAM is used as a work area when the CPU executes a program.

The image forming section 10 is provided with a process cartridge 100. The process cartridge 100 can be detached from the image forming apparatus 1 by being pulled out toward the front side (i.e., the near side in FIG. 1) of the image forming apparatus 1. In this exemplary embodiment, the process cartridge 100 may be detached from the image forming apparatus 1 so as to attach another process cartridge 100 thereto.

The process cartridge 100 is provided with a photoconductor drum 11, a charging device 12, a developing device 14, and a cleaning device 16. Moreover, a memory M formed of an electrically erasable and programmable ROM (EEPROM) is attached to the process cartridge 100. The memory M stores information indicating the type of the process cartridge 100 and information related to the usage status of the process cartridge 100, such as the number of rotation of the photoconductor drum 11. The image forming apparatus 1 according to this exemplary embodiment is provided with an exposure device 13 and a transfer device 15 as an example of a transfer unit that rotates while nipping a sheet P together with the photoconductor drum 11 so as to transfer a toner image onto the sheet P. Moreover, the image forming apparatus 1 is provided with a read-write device YK that reads information from the memory M and writes information onto the memory M.

The photoconductor drum 11 provided in the process cartridge 100 is provided with a photosensitive layer around the outer peripheral surface thereof and is rotated in a direction indicated by an arrow in FIG. 1 by driving a driving source (not shown). The charging device 12 has a charging roller that is in contact with the photoconductor drum 11 and electrostatically charges the photoconductor drum 11 to a predetermined electric potential. The exposure device 13 radiates laser light onto the photoconductor drum 11 so that the photoconductor drum 11 electrostatically charged by the charging device 12 is selectively exposed to the laser light, thereby forming an electrostatic latent image on the photoconductor drum 11. The developing device 14 has a developing roller and forms a toner image on the photoconductor drum 11.

More specifically, the developing device 14 accommodates therein a two-component developer containing a negatively-charged toner and a positively-charged carrier. The developing device 14 develops the electrostatic latent image formed on the photoconductor drum 11 by using the toner so as to form a toner image on the photoconductor drum 11. The transfer device 15 has a roller-shaped member and generates an electric field in an area (i.e., transfer area Tp) between the transfer device 15 and the photoconductor drum 11. At the same time, the transfer device 15 rotates in accordance with rotation of the photoconductor drum 11 so as to transfer the toner image on the photoconductor drum 11 onto the sheet P. The cleaning device 16 has a cleaning blade that is in contact with the photoconductor drum 11 and uses this cleaning blade to remove residual toner and the like from the photoconductor drum 11. In this exemplary embodiment, the process cartridge 100 and the exposure device 13 described above may be defined as an example of a toner-image forming unit that forms a toner image.

The fixing section 20 heats the toner image formed on the sheet P by the image forming section 10 so as to fix the toner image onto the sheet P. In this exemplary embodiment, the fixing section 20 includes a heating roller 21 having a built-in heating source, a pressing roller 22 disposed facing the heating roller 21 and nipping the sheet P together with the heating roller 21, a guide member 23 that guides the sheet P having the toner image fixed thereon, and claw members 24 that are attached to the guide member 23 and separate the sheet P from the heating roller 21 by penetrating between the heating roller 21 and the sheet P.

The built-in heating source in the heating roller 21 is, for example, a halogen heater that generates heat so as to heat the surface of the heating roller 21 to a predetermined temperature. Thus, when the sheet P is transported to the fixing section 20 and comes into contact with the heating roller 21, the sheet P is heated so that the toner image formed on the sheet P becomes fixed thereto. In this exemplary embodiment, the heating roller 21 may be defined as a fixing member that fixes a toner image onto a sheet P.

The pressing roller 22 comes into pressure contact with the outer surface of the heating roller 21 so as to become closely attached to the heating roller 21, thereby forming a fixation pressing area (i.e., nip) therebetween. The heating roller 21 is connected to a driving source, such as a motor. When the heating roller 21 is rotated by this driving source, the pressing roller 22 is rotated correspondingly. Therefore, when the sheet P is transported to the fixation pressing area, the sheet P is nipped and transported by the two rollers. In this exemplary embodiment, the pressing roller 22 may be defined as an example of a fixation pressing member that comes into pressure contact with the outer peripheral surface of the heating roller 21 so that a fixation pressing area through which a sheet P bearing an unfixed image thereon passes is formed between the pressing roller 22 and the heating roller 21. Furthermore, in this exemplary embodiment, the heating roller 21 and the pressing roller 22 constitute a fixing unit.

The guide member 23 is disposed between the fixing unit and the output roller 75 and guides the sheet P passing through the fixation pressing area toward the output roller 75. In other words, the guide member 23 guides the sheet P passing through the fixing unit toward the output roller 75. Specifically, the guide member 23 has a substantially rib-shaped guide, which will be described in detail later, at a predetermined position, and the transport direction of the sheet P is defined by the guide and the sheet P coming into contact with each other. Then, the sheet P is guided to the output roller 75 by the guide member 23.

The claw members 24 each have a claw (not shown) at an end thereof for separating the sheet P from the heating roller 21. The claw members 24 are biased toward the heating roller 21 by an elastic member, such as a spring (not shown). As a result, the claw at the end of each claw member 24 comes into contact with the heating roller 21 with a predetermined pressure so as to become closely attached thereto. When the sheet P adhered to the heating roller 21 is transported in this state, the claw at the end of each claw member 24 penetrates between the heating roller 21 and the sheet P so as to separate the sheet P from the heating roller 21. Then, the separated sheet P is guided along the upper surface of the claw member 24 so as to be sent to the guide member 23.

The sheet feeding section 30 includes first to third sheet feeders 31 to 33 such that sheets P of different sizes can be fed to the image forming section 10. The first to third sheet feeders 31 to 33 have the same configuration. Referring to the first sheet feeder 31 as an example, the first sheet feeder 31 includes a sheet accommodation portion 41 as an example of a recording-medium accommodation portion that accommodates sheets P, a fetching roller 43, and a separation mechanism 44. The sheet accommodation portion 41 has a rectangular-parallelepiped shape with an opening at the top thereof and accommodates multiple sheets P therein. The fetching roller 43 comes into contact with the uppermost sheet P of the stack of sheets P accommodated in the sheet accommodation portion 41 and sends the uppermost sheet P toward the separation mechanism 44. The separation mechanism 44 includes, for example, a rotatable feed roller and a retard roller whose rotation is limited, and separates the sheets P sent from the fetching roller 43 in a one-by-one fashion.

The sheet feeding section 30 is provided with a registration roller 852. The registration roller 852 stops rotating so as to temporarily stop the transported sheet P, and then starts rotating again at a predetermined timing so as to feed the sheet P toward the transfer area Tp while performing registration adjustment on the sheet P. Furthermore, the sheet feeding section 30 is provided with a first transport roller 55 and a second transport roller 65 as transport units. The first transport roller 55 transports a sheet P transported from the second sheet feeder 32 toward the registration roller 852 and the transfer area Tp. The second transport roller 65 transports a sheet P transported from the third sheet feeder 33 toward the first transport roller 55.

The sheet inverting mechanism 40 inverts the sheet P passing through the fixing section 20 so as to feed the sheet P again to the transfer area Tp. Specifically, the sheet inverting mechanism 40 is an example of an inverting unit that inverts a first face and a second face of the sheet P after a toner image is fixed onto the first face of the sheet P by the fixing section 20 and then feeds the sheet P again to the transfer device 15. Moreover, the sheet inverting mechanism 40 is provided with a transport roller 48 that transports the sheet P along an inversion transport path SR.

The output roller 75 transports the sheet P output from the fixing section 20 and guided by the guide member 23 so as to output the sheet P onto the sheet stack section YS.

The output roller 75 includes a first output roller 75a and a second output roller 75b. As will be described later, the second output roller 75b is attached by using second-output-roller attachment portions provided in the guide member 23.

The first output roller 75a is connected to a driving source, such as a motor (not shown). The first output roller 75a is rotated by this driving source. The second output roller 75b is rotated in accordance with the rotation of the first output roller 75a. The first output roller 75a and the second output roller 75b nip and transport the sheet P.

The linear speed at the surface of the first output roller 75a is set to be higher than the linear speed at the surfaces of the heating roller 21 and the pressing roller 22. Specifically, the rotation speed of the first output roller 75a is set such that the sheet P is transported at a speed that is higher than the linear speed at the outer peripheral surface of the heating roller 21 as an example of a fixing member and the outer peripheral surface of the pressing roller 22 as an example of a fixation pressing member. Thus, tensile stress acts on the sheet P, thereby suppressing the occurrence of sagging of the sheet P. In addition, a transport path for the sheet P can be ensured, thereby suppressing the occurrence of jamming of the sheet P. In this case, the force that supports the sheet P due to the pressure contact between the heating roller 21 and the pressing roller 22 at the fixation pressing area is larger than the pulling force applied to the sheet P by the first output roller 75a. Therefore, even if the rotation speed of the first output roller 75a is set as described above, the sheet P is not transported at the linear speed of the surface of the first output roller 75a in actuality, thus causing slippage to occur between the first output roller 75a and the sheet P. By causing this slippage, the sheet P may be prevented from being pulled excessively by the first output roller 75a.

The image forming apparatus 1 is provided with a sheet transport path YR that makes each sheet P accommodated in the sheet feeding section 30 to travel through the registration roller 852, the transfer area Tp, and the fixing section 20. Furthermore, in the image forming apparatus 1, the sheet inverting mechanism 40 is provided with the inversion transport path SR that diverges from the sheet transport path YR at the downstream side of the fixing section 20 and merges with the sheet transport path YR at the upstream side of the registration roller 852. The inversion transport path SR is used when performing duplex printing on the sheet P, that is, when forming an image on the second face of the sheet P in addition to the first face thereof.

### Image Forming Operation

When an image is to be formed on a sheet P, image data generated in the personal computer (not shown) or the like is received by the receiver 400, and the receiver 400 outputs the image data to the image processor 600. The image processor 600 then performs image processing on the image data. The processed image data is output to the exposure device 13. The exposure device 13 having received the image data selectively exposes the photoconductor drum 11 electrostatically charged by the charging device 12 to light, thereby forming an electrostatic latent image on the photoconductor drum 11. The formed electrostatic latent image is developed into, for example, a black (K) toner image by the developing device 14. In other words, the image forming apparatus 1 according to this exemplary embodiment develops a monochrome toner image.

In the sheet feeding section 30, the fetching roller 43 rotates in accordance with an image formation timing, and sheets P are fed from one of the sheet accommodation portions 41. Each of the sheets P separated in a one-by-one fashion by the separation mechanism 44 is transported to the registration roller 852, where the sheet P is temporarily stopped. Subsequently, the registration roller 852 rotates in accordance with a rotation timing of the photoconductor drum 11, thereby feeding the sheet P to the transfer area Tp. At the transfer area Tp, the toner image formed on the photoconductor drum 11 is transferred onto the sheet P. In this case, the photoconductor drum 11 may be defined as a rotating member used for performing the transfer process.

Subsequently, the sheet P having the toner image transferred thereon undergoes a fixing process in the fixing section 20, and is output by the output roller 75 onto the sheet stack section YS located below the scanner 200.

When duplex printing is to be performed on the sheet P, the sheet P passing through the fixing section 20 is transported toward the sheet stack section YS by the output roller 75. However, the output roller 75 does not completely output the sheet P, but stops rotating at an intermediate position of the sheet P. Then, the output roller 75 rotates in the opposite direction relative to the direction for outputting the sheet P in accordance with a start timing for forming an image on the sheet P by the image forming section 10, thereby transporting the sheet P to the inversion transport path SR. By traveling through the sheet inverting mechanism 40, the sheet P is inverted and is fed again to the transfer area Tp. At the transfer area Tp, the toner image formed on the photoconductor drum 11 is transferred onto the second face of the sheet P. The sheet P having the toner image additionally transferred on the second face thereof undergoes the fixing process in the fixing section 20. Then, the sheet P having the images formed thereon is output onto the sheet stack section YS.

### Guide Member

Next, the guide member 23 will be described in more detail.

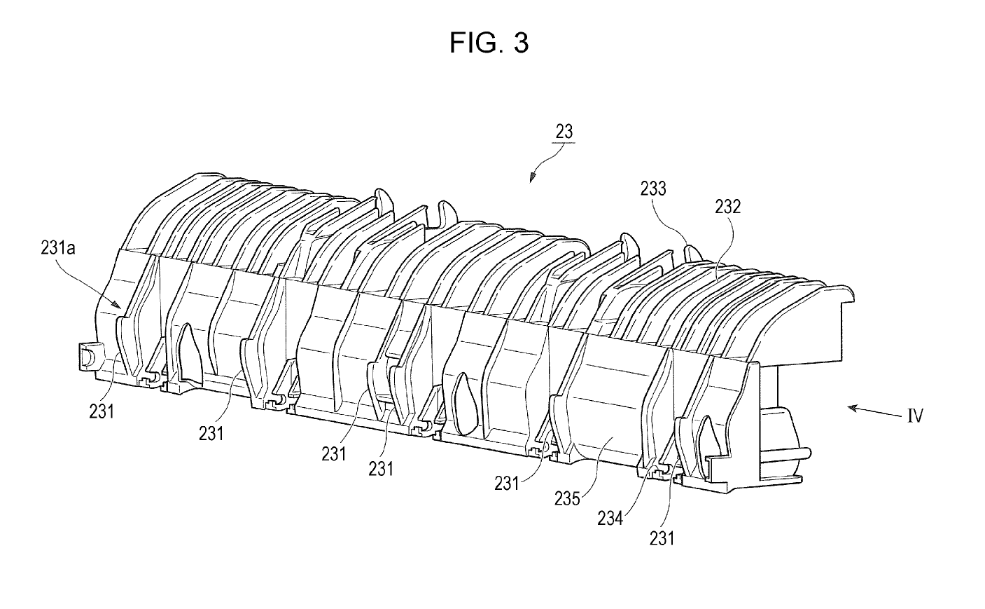

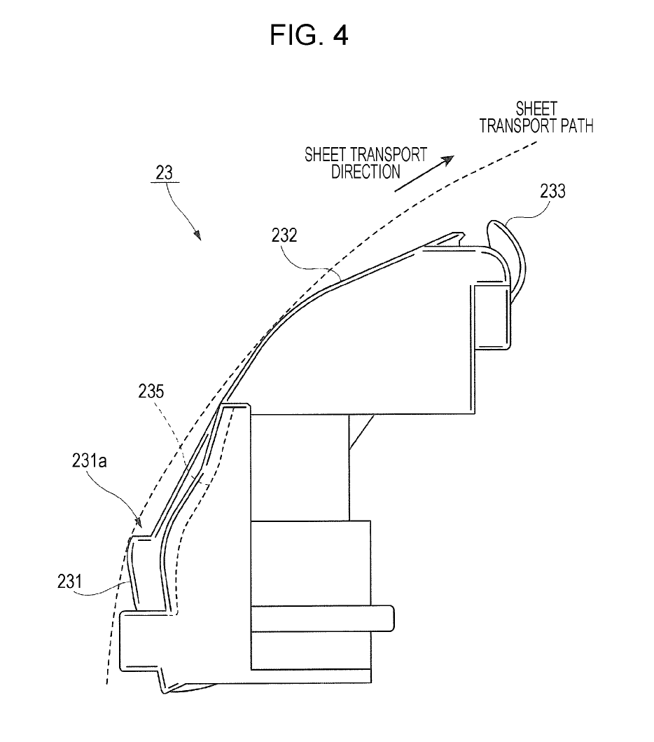

FIG. 3 is a perspective view of the guide member 23. FIG. 4 illustrates the guide member 23, as viewed from a direction indicated by an arrow IV in FIG. 3.

As shown in the drawings, the guide member 23 includes ribs 231 that extend in the transport direction of the sheet P and are disposed at the upstream side in the transport direction of the sheet P, ribs 232 that extend in the transport direction of the sheet P and are disposed at the downstream side in the transport direction of the sheet P, second-output-roller attachment portions 233 used for attaching the second output roller 75b (see FIG. 2) thereto, and claw-member attachment portions 234 for attaching the claw members 24 (see FIG. 2) thereto. As shown in FIG. 3, six ribs 231 are provided in the guide member 23. In this exemplary embodiment, these multiple ribs 231 serve as a substantially rib-shaped guide extending in the transport direction of the sheet P. The ribs 231 are formed on a rib formation surface 235 as an example of a guide formation surface.

The ribs 231 and the ribs 232 guide the sheet P by coming into contact with the sheet P at predetermined positions. The sheet P first comes into contact with a predetermined position of each rib 231 and then comes into contact with a predetermined position of each rib 232 so that a substantially arc-shaped transport path for transporting the sheet P is formed. Then, the leading edge of the sheet P is introduced into the nip between the first output roller 75a and the second output roller 75b (see FIG. 2) of the output roller 75. When the leading edge of the sheet P enters the nip between the first output roller 75a and the second output roller 75b, the sheet P is nipped between the first output roller 75a and the second output roller 75b and is pulled by the rotational force of the first output roller 75a. Thus, the sheet P is further transported toward the sheet stack section YS (see FIG. 1) from the output roller 75.

In this exemplary embodiment, the sheet P is made to come into contact with areas of the guide member 23 where the ribs 231 and the ribs 232 extending in the transport direction of the sheet P are formed, thereby reducing a frictional force between the sheet P and the guide member 23.

Multiple roller components that constitute the second output roller 75b are fitted around a shaft (not shown), and the second-output-roller attachment portions 233 are provided for attaching this shaft thereto. Thus, the second output roller 75b is disposed at a predetermined position.

The claw-member attachment portions 234 are provided for attaching the multiple claw members 24 thereto. The claw members 24 are attached to the claw-member attachment portions 234 in a rotatable manner in the direction of the normal to the sheet transport plane. The claw members 24 are biased toward the heating roller 21 (see FIG. 2) by an elastic member, such as a spring (not shown), so that the end of each claw member 24 is closely attached to the heating roller 21. When the sheet P is output from the fixation pressing area while the sheet P is still adhered to the heating roller 21, the ends of the claw members 24 penetrate between the sheet P and the heating roller 21 so as to separate the sheet P from the heating roller 21. In this exemplary embodiment, five claw-member attachment portions 234 are provided, and five claw members 24 are respectively attached thereto.

As mentioned above, the linear speed at the surface of the first output roller 75a is set to be higher than the linear speed at the surfaces of the heating roller 21 and the pressing roller 22. Accordingly, when the sheet P is transported by the output roller 75, tensile stress acts on the sheet P. Due to this tensile stress, the sheet P is pressed onto the guide member 23 as the sheet P is guided by the guide member 23. The pressing force is large especially where the sheet P comes into contact with the ribs 231.

When the sheet P travels along the guide member 23, the temperature of the sheet P is relatively high since the sheet P has just passed through the fixation pressing area. Therefore, the toner image formed on the sheet P is still soft and may readily become separated therefrom. When the sheet P in this state is firmly pressed onto the ribs 231 of the guide member 23, a frictional force generated between the sheet P and the ribs 231 may cause the fixed toner to separate from the sheet P and adhere to and accumulate on the ribs 231. An area where the toner accumulates is located downstream of and adjacent to the area where the sheet P comes into contact with the ribs 231, as viewed in the transport direction of the sheet P. When the accumulated toner exceeds a certain amount, the toner adheres again onto the transported sheet P, thus contaminating the sheet P by forming streaks extending in the sheet transport direction thereon.

In this exemplary embodiment, this phenomenon is suppressed by providing recesses at the downstream side, in the transport direction of the sheet P, of the area where the sheet P comes into contact with the ribs 231. Each of these recesses is recessed inward from the substantially arc-shaped transport path. Specifically, each recess is provided by forming a cutout 231a at the toner accumulation position of each rib 231.

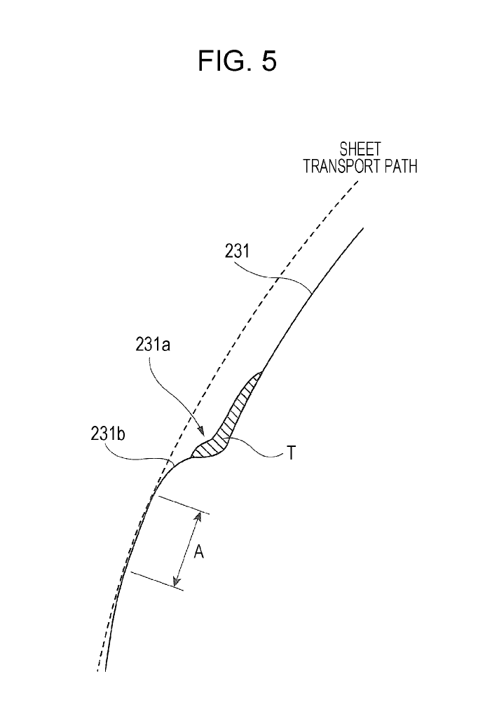

FIG. 5 illustrates the cutout 231a formed in each rib 231.

FIG. 5 is an enlarged view of the area where the cutout 231a is formed in FIG. 4. An area A in FIG. 5 denotes the area where the sheet P comes into contact with the rib 231. In this exemplary embodiment, the cutout 231a is provided downstream of and adjacent to the area A in the transport direction of the sheet P. As shown in FIG. 5, a toner T separated from the sheet P accumulates in the cutout 231a. In other words, the cutout 231a functions as a toner accumulation section in which the toner T separated from the sheet P due to the sheet P coming into contact with the rib 231 is accumulated.

In this exemplary embodiment, supposing that the cutout 231a is formed within the area A instead of being formed at the position shown in FIG. 5, an edge 231b formed as a result of forming the cutout 231a would come into contact with the sheet P. In that case, the edge 231b may damage the sheet P and cause deformation in the form of a streak extending in the sheet transport direction to occur in the sheet P. Therefore, the cutout 231a is formed outside the area A.

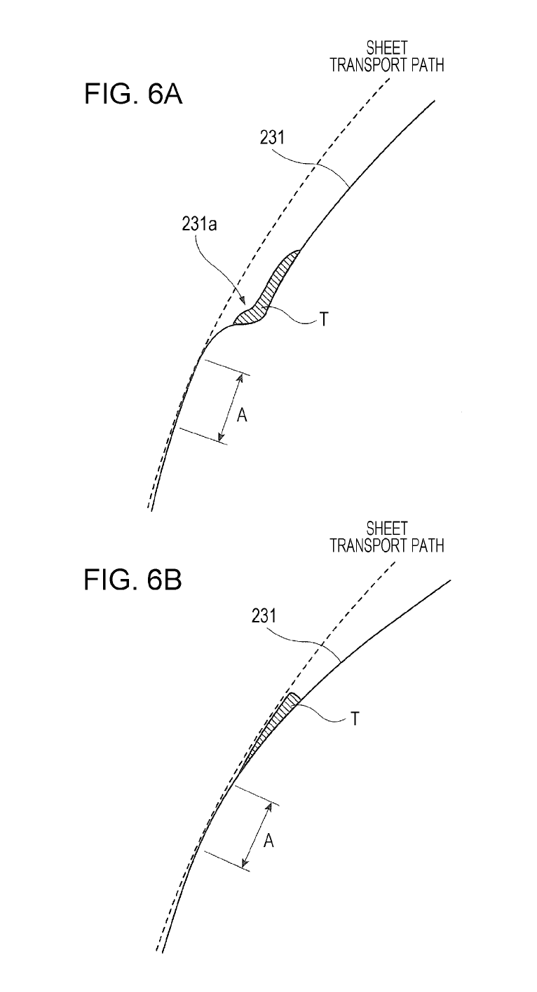

FIGS. 6A and 6B illustrate a comparison of the accumulation state of the separated toner T, between an example provided with the cutouts 231a and an example not provided with the cutouts 231a. Specifically, FIG. 6A corresponds to the example provided with the cutouts 231a and is the same as FIG. 5. On the other hand, FIG. 6B corresponds to the example not provided with the cutouts 231a.

In FIG. 6B, the separated toner T accumulates in an area located downstream of and adjacent to the area where the sheet P comes into contact with the ribs 231, as viewed in the transport direction of the sheet P, as in the example shown in FIG. 6A. However, since the cutouts 231a are not provided, the distance between the toner T and the sheet P is short. Therefore, the accumulated toner T may readily adhere again onto the sheet P. In contrast, in FIG. 6A, if the separated toner T accumulates on the ribs 231, the toner T would accumulate in the cutouts 231a. Therefore, the accumulated toner T is distant from the sheet P, thus reducing the possibility of the accumulated toner T adhering again onto the sheet P.

If the toner T accumulates to a position higher than that in the example shown in FIG. 6B, the toner T may possibly adhere again onto the sheet P. However, it is difficult for the toner T accumulated on the narrow ribs 231 to reach the sheet P. Specifically, before the accumulated toner T reaches the sheet P, the toner T altogether is likely to separate and fall off from the ribs 231 due to the effect of, for example, vibration. In view of these points, the cutouts 231a may be formed deeper. For example, the bottom of each cutout 231a may be set at about the same height as the rib formation surface 235 (see FIG. 3).

With the guide member 23 according to this exemplary embodiment described above, the separated toner T is unlikely to adhere again onto the sheet P, thereby suppressing streak-shaped contamination of the sheet P.

The guide member 23 may be manufactured by, for example, an injection molding technique using a resin material. In this case, the ribs 231 having the cutouts 231a may be formed together at the same time. Alternatively, the cutouts 231a may be formed by cutting the ribs 231 after manufacturing the guide member 23. Such an alternative technique for manufacturing the guide member 23 according to this exemplary embodiment is not to be excluded.

As a conceivable alternative exemplary embodiment, for example, a roller may be attached to the area A so as to suppress the separation of the toner from the sheet P. Specifically, the sheet P is guided by bringing the sheet P into contact with this roller and then rotating the roller. In this case, the friction between the roller and the sheet P is small since the roller rotates. Therefore, the small friction may suppress the separation of the toner from the sheet P. In such an alternative exemplary embodiment, however, the guide member 23 becomes complicated in shape since the roller is to be attached thereto, and additional components, such as the roller and a shaft for attaching the roller thereto, are provided. Therefore, the manufacturing cost of the guide member 23 increases.

As another conceivable alternative exemplary embodiment, for example, a shaft provided with a coating for reducing friction may be disposed in the area A. In this case, since the friction between the shaft and the sheet P is similarly reduced, the reduced friction may suppress the separation of the toner from the sheet P. In such an alternative exemplary embodiment, however, the guide member 23 becomes complicated in shape since the shaft is to be attached thereto, and an additional component, such as the shaft, is provided. Therefore, the manufacturing cost of the guide member 23 increases. In addition, there is a problem in that the lifespan of the guide member 23 is short since the friction-reducing coating on the shaft may readily delaminate.

In contrast, the aforementioned additional components are not included in the above exemplary embodiment. Therefore, the manufacturing cost of the guide member 23 may be reduced while preventing the separated toner from adhering again onto the sheet P.

In the exemplary embodiment described above in detail, the image forming apparatus 1 is an apparatus that forms an image by using a toner of a single color. Alternatively, the image forming apparatus 1 may be an apparatus that forms a full-color image by using toners of multiple colors, such as yellow (Y), magenta (M), cyan (C), and black (K).

Furthermore, in the exemplary embodiment described above in detail, the fixing unit is of a so-called two-roller type constituted of two rollers, i.e., the heating roller 21 and the pressing roller 22. Alternatively, one of or each of these two rollers may be a belt member.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a fixing unit having a fixing member that fixes a toner image onto a recording medium and a fixation pressing member that comes into pressure contact with an outer peripheral surface of the fixing member so that a fixation pressing area through which the recording medium bearing an unfixed image passes is formed between the fixation pressing member and the fixing member;
a transport unit that transports the recording medium output from the fixing unit; and
a guide unit that is disposed between the fixing unit and the transport unit and has a substantially arc-shaped transport path along which the recording medium output from the fixing unit is guided and transported toward the transport unit,
wherein the guide unit has
a substantially rib-shaped guide that extends along the transport path for the recording medium and comes into contact with the recording medium at a predetermined position of the guide so as to guide the recording medium, and
a recess that is provided downstream, in a transport direction of the recording medium, of the predetermined position of the guide and is recessed inward from the substantially arc-shaped transport path.

2. The image forming apparatus according to claim 1, wherein the recess in the guide unit functions as an area where a toner separated from the recording medium due to the recording medium coming into contact with the guide is accumulated.

3. The image forming apparatus according to claim 1, wherein the transport unit is set so as to transport the recording medium at a speed that is higher than a linear speed at the outer peripheral surface of the fixing member and an outer peripheral surface of the fixation pressing member.

4. The image forming apparatus according to claim 1, wherein the guide unit has a guide formation surface on which the guide is formed, and
wherein a bottom of the recess in the guide unit is set at about the same height as the guide formation surface.

5. A fixing device comprising:
a fixing member that fixes a toner image onto a recording medium;
a fixation pressing member that comes into pressure contact with an outer peripheral surface of the fixing member so that a fixation pressing area through which the recording medium bearing an unfixed image passes is formed between the fixation pressing member and the fixing member; and
a guide unit that has a substantially arc-shaped transport path along which the recording medium passing through the fixation pressing area is guided,
wherein the guide unit has
a substantially rib-shaped guide that extends along the transport path for the recording medium and comes into contact with the recording medium at a predetermined position of the guide so as to guide the recording medium, and
a toner accumulation section that is provided downstream, in a transport direction of the recording medium, of the predetermined position of the guide and is where a toner separated from the recording medium due to the recording medium coming into contact with the guide is accumulated.

6. The fixing device according to claim 5, wherein the toner accumulation section is provided by forming an area located downstream, in the transport direction of the recording medium, of the predetermined position of the guide into a shape that is recessed inward from the substantially arc-shaped transport path.
